(19) United States
(12) Patent Application Publication
(10) Pub. No.: US 2025/0299338 A1
(43) Pub. Date: Sep. 25, 2025

(54) EXTENSION OF IACS FRAMEWORK TO SECRETOME APPLICATIONS

(71) Applicants: SONY GROUP CORPORATION, Tokyo (JP); Sony Corporation of America, New York, NY (US)

(72) Inventors: Su-Hui Chiang, San Jose, CA (US); Haipeng Tang, Sunnyvale, CA (US); Thanh Chau Nguyen, San Jose, CA (US); Michael Zordan, Boulder Creek, CA (US); Ko-Kai Albert Huang, Saratoga, CA (US); Ming-Chang Liu, San Jose, CA (US)

(21) Appl. No.: 18/957,424

(22) Filed: Nov. 22, 2024

Related U.S. Application Data
(60) Provisional application No. 63/567,988, filed on Mar. 21, 2024.

(51) Int. Cl. G06T 7/00; G01N 15/10; G01N 15/14; G01N 15/1433

(52) U.S. Cl. CPC G06T 7/0014; G01N 15/1433; G01N 15/1459; G01N 2015/1006; G01N 2015/1028

(57) ABSTRACT

A secretion analysis and sorting system where cell(s) are deposited into a carrier that will capture any secretions from the cell, and is small enough to be sorted using flow cytometry based cell sorting, is described herein. The use of an image classification workflow that identifies the event types present in a sample of carriers allows the user to select which event types they would like to purify, and then train a supervised classification system that will be used to make real time sort decisions to purify the carriers which contain cells that secrete the desired product. A flow cytometer is then able to be used to screen the individual carriers to see if each one has the desired secreted product.

### CROSS-REFERENCE TO RELATED APPLICATION(S)

This application claims priority under 35 U.S.C. § 119(e) of the U.S. Provisional Patent Application Ser. No. 63/567,988, filed Mar. 21, 2024 and titled, “EXTENSION OF IACS FRAMEWORK TO SECRETOME APPLICATIONS,” which is hereby incorporated by reference in its entirety for all purposes.

### FIELD OF THE INVENTION

The present invention relates to cell sorting. More specifically, the present invention relates to image-based cell sorting.

### BACKGROUND OF THE INVENTION

Cells secrete products such as proteins and antibodies. The study of these secreted products (secretome) has been revolutionary for the understanding of cellular biology. The analysis and purification of cells that secrete specific biomolecules is required to produce biologic drugs like antibody therapies. Improving the ability to analyze and purify cells based on their secreted products will accelerate the development of the next generation of cell and antibody therapies.

In secretion-based sorting, cells are clonally isolated, and the secreted products are contained. Previously, the work used multi-well plates, which required expertise and expensive dedicated equipment.

### SUMMARY OF THE INVENTION

A secretion analysis and sorting system where cell(s) are deposited into a carrier that will capture any secretions from the cell, and is small enough to be sorted using flow cytometry based cell sorting, is described herein. The use of an image classification workflow that identifies the event types present in a sample of carriers allows the user to select which event types they would like to purify, and then train a supervised classification system that will be used to make real time sort decisions to purify the carriers which contain cells that secrete the desired product. A flow cytometer is then able to be used to screen the individual carriers to see if each one has the desired secreted product.

In one aspect, a method comprises pre-training a feature encoder using cell images, performing unsupervised clustering on the cell images to generate a plurality of clusters, wherein each cluster of the plurality of clusters is based on a number of cells in a carrier, implementing a classifier to fine-tune supervised classification and performing real-time classification of cells during active sorting using the classifier. The method further comprises populating a plurality of carriers with a plurality of cells. The method further comprises acquiring images of the carriers to generate the cell images. The feature encoder detects a target cell, a secretor cell or a secretion. A cluster of the plurality of clusters includes a single cell in each carrier. The carrier comprises a double emulsion. Each cluster of the plurality of clusters is based on intensity and/or location of a fluorescence secretion signal.

In another aspect, an apparatus comprises a non-transitory memory for storing an application, the application for: pre-training a feature encoder using cell images, performing unsupervised clustering on the cell images to generate a plurality of clusters, wherein each cluster of the plurality of clusters is based on a number of cells in a carrier, implementing a classifier to fine-tune supervised classification and performing real-time classification of cells during active sorting using the classifier and a processor coupled to the memory, the processor configured for processing the application. The plurality of carriers are populated with a plurality of cells. The application is further for acquiring images of the carriers to generate the cell images. The feature encoder detects a target cell, a secretor cell or a secretion. A cluster of the plurality of clusters includes a single cell in each carrier. The carrier comprises a double emulsion. Each cluster of the plurality of clusters is based on intensity and/or location of a fluorescence secretion signal.

In another aspect, a system comprises a first device configured for acquiring images of carriers and a second device configured for: pre-training a feature encoder using cell images, performing unsupervised clustering on the cell images to generate a plurality of clusters, wherein each cluster of the plurality of clusters is based on a number of cells in a carrier, implementing a classifier to fine-tune supervised classification and performing real-time classification of cells during active sorting using the classifier. The plurality of carriers are populated with a plurality of cells. The second device is further configured for generating the cell images from the carriers. The feature encoder detects a target cell, a secretor cell or a secretion. A cluster of the plurality of clusters includes a single cell in each carrier. The carrier comprises a double emulsion. Each cluster of the plurality of clusters is based on intensity and/or location of a fluorescence secretion signal.

### BRIEF DESCRIPTION OF THE DRAWINGS

FIG. 1 illustrates a diagram of antibody discovery according to some embodiments.

FIG. 2 illustrates a diagram of an Image Activated Cell Sorter (IACS) workflow according to some embodiments.

FIG. 3 illustrates a flowchart of a method of utilizing an IACS with secretome applications according to some embodiments.

FIG. 4 shows a block diagram of an exemplary computing device configured to implement the IACS framework according to some embodiments.

FIG. 5 illustrates a diagram schematically showing the overall configuration of a biological sample analyzer according to some embodiments.

### DETAILED DESCRIPTION OF THE PREFERRED EMBODIMENT

The extension of IACS framework to secretome applications described herein is related to U.S. Patent Application No. *Atty. Docket No. Sony-77800*, filed ***, and titled “CELL ENUMERATION MODULE FOR SECRETION SORTING” and U.S. Patent Application No. *Atty. Docket No. Sony-78000*, filed ***, and titled “AUTOMATIC ANNOTATION OF EVENT TYPES IN IACS WORKFLOW,” both of which are incorporated by reference in their entireties for all purposes.

Secretomics is an emerging area of study that is important to antibody discovery, biologics production and cell manufacturing. A secretion analysis and sorting system where cell(s) are deposited into a carrier that will capture any secretions from the cell, and is small enough to be sorted using flow cytometry based cell sorting, is described herein. The use of an image classification workflow that identifies the event types present in a sample of carriers allows the user to select which event types they would like to purify, and then train a supervised classification system that will be used to make real time sort decisions to purify the carriers which contain cells that secrete the desired product.

Carriers are able to store one or more cells. The carriers isolate the one or more cells. If a cell secretes a product, the secretion will stay within the carrier. In some embodiments, the carrier is a double emulsion. A double emulsion is where a droplet has smaller droplets contained within them. For example, a droplet of aqueous medium containing a cell is enclosed by an oil droplet that separates the interior aqueous droplet from the bulk aqueous culture media. This is referred to as a water in oil in water (W/O/W) double emulsion. The carriers are able to be approximately 30-80 microns in diameter (although, other sizes and shapes are possible). A flow cytometer is then able to be used to screen the individual carriers to see if each one has the desired secreted product. Millions of carriers are able to be placed in a tube (or other container) to do a large amount of sample preparation at once, instead of doing a plate-based approach which is much more complicated and a much slower process. Additionally, using a flow cytometer, screening is much faster. For example, roughly 1,000 cells are able to be screened in 20-30 minutes using the plate-based approach, whereas 3,000 cells per second are able to be screened using a flow cytometer.

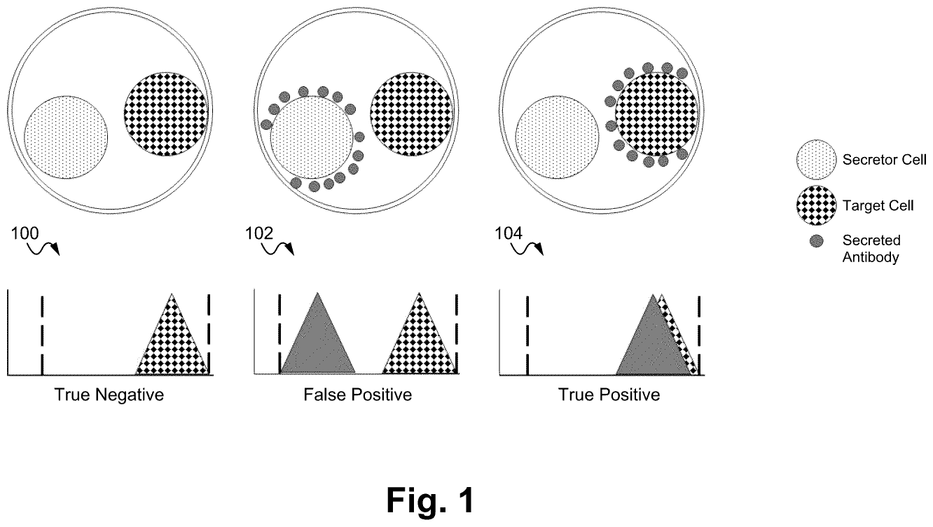

FIG. 1 illustrates a diagram of antibody discovery according to some embodiments. In each carrier, there is a donor/secretor cell and a target cell. A secretor cell is a cell that has been perturbed by exposure to an antigen or another means. A target cell is a cell that is known to express a desired outcome (e.g., a cell to bind with the secretor cell or an antibody from the secretor cell).

A tube or carrier is seeded with the target cell and a first fluorescent stain. The tube or carrier is also seeded with the secretor cell and a second fluorescent stain. A third fluorescent stain is included for the secretions (e.g., secreted or secondary antibody).

A true negative is detected when no antibodies are detected (e.g. the third fluorescent stain is not detected), as shown in 100. A false positive is detected when antibodies are detected as well as target cell, but when the antibodies are not proximate to the target cell, as shown in 102. A true positive is detected when antibodies are detected as well as target cell, and when the antibodies are proximate to the target cell, as shown in 104.

In systems simply using total fluorescence (or intensity), false positives such as shown in 102 are possible, since they do not acquire spatial information. By looking at total fluorescence, scenarios 100 and 102 appear the same, even though only scenario 102 is a true positive.

By utilizing a cell sorter and classification system designed to perform pattern recognition, the specific pattern of antibodies detected near a target cell are able to be appropriately detected, classified and sorted. For example, a feature encoder is able to be used which is described in U.S. patent application Ser. No. 17/222,131, filed on Apr. 5, 2021, titled, “A FRAMEWORK FOR IMAGE BASED UNSUPERVISED CELL CLUSTERING AND SORTING,” which is hereby incorporated by reference in its entirety for all purposes. Additionally, the classification workflow is described in U.S. patent application Ser. No. 17/531,124, filed on Nov. 19, 2021, titled, “CLASSIFICATION WORKFLOW FOR FLEXIBLE IMAGE BASED PARTICLE SORTING,” which is hereby incorporated by reference in its entirety for all purposes.

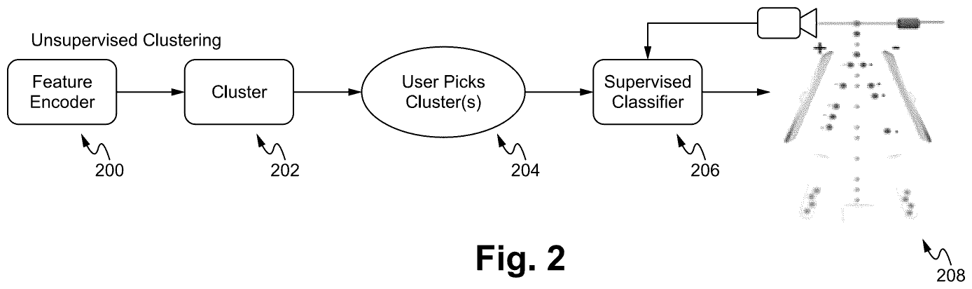

FIG. 2 illustrates a diagram of an Image Activated Cell Sorter (IACS) workflow according to some embodiments. The IACS workflow is described in the incorporated applications. In the step 200, a neural network-based feature encoder is employed to extract features of cell images. In the step 202, cells are automatically clustered based on extracted cell features. For example, a sample is provided, and several different clusters are found using unsupervised clustering (e.g., empty carriers is one cluster, one cell in each carrier is a second cluster, and so on). In the step 204, a user is then able to look at the cell images to identify the cluster to be sorted (e.g., high secretor or proper fluorescent staining in localization for the antibody discovery application). The extracted feature from that cluster is then used to fine-tune a classifier network (neural network), in the step 206. By fine-tuning the classifier network, then just that specific type of cell or event (e.g., carriers with a single cell) is able to be identified by the classification network to sort cells in real-time live sorting, in the step 208. For example, the decisions are made in less than 1 millisecond (e.g., 0.5 milliseconds).

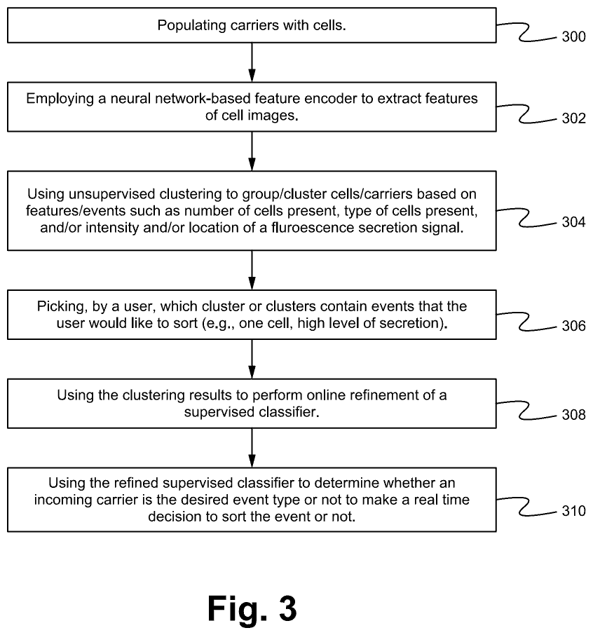

FIG. 3 illustrates a flowchart of a method of utilizing an IACS with secretome applications according to some embodiments. In the step 300, carriers are populated with cells. The carriers are able to be populated in any manner such as pipetting.

In the step 302, a neural network-based feature encoder is employed to extract features of cell images. The features are able to include secretor cells, target cells, and secretions (e.g., antibodies). A specified number of cells are run through the system. The feature encoder is able to indicate to the user what is in a sample. As a cell goes through the feature encoder, the feature encoder detects/measures feature values from the image. Image processing techniques are able to be used to extract features. For example, image processing is able to be used to detect a change in color which indicates a border of an object within an image. The image processing is also able to determine a distance of each border and/or object.

In the step 304, unsupervised clustering is used to group/cluster cells/carriers based on features/events such as number of cells present, type of cells present, and/or intensity and/or location of a fluroescence secretion signal. For example, based on the fluorescence and imaging analysis, if two distinct circles (approximate circles) and/or other distinct cell features are detected, then two cells are determined to be detected. In some embodiments, the unsupervised clustering uses the output of the feature encoder to group/classify the cells into clusters. The clustering of the cells is able to be performed in any manner (e.g., based on detected features, size, and/or any other characteristic).

In the step 306, a user picks which cluster or clusters contain events that the user would like to sort (e.g., one cell, high level of secretion). For example, the user only wants the cluster with carriers with a single cell. In another example, the user only wants the cluster with carriers with a secretor cell, a target cell and antibodies that are located near the target cell (e.g., the antibodies are within a threshold distance from the target cell). The user picking the cluster is able to be performed manually. In some embodiments, instead of a human user picking a cluster or clusters, a device using artificial intelligence/machine learning is able to pick the cluster or clusters.

In the step 308, the clustering results are used to perform online refinement of a supervised classifier. The classifier results/labeling from the unsupervised clustering are able to be used by the classifier, such as to fine-tune a shallow or convolutional neural network.

In the step 310, the refined supervised classifier is used to determine whether an incoming carrier is the desired event type or not to make a real time decision to sort the event or not. The trained classifier is used to do the real time classification based on the sorting classifications. Unlike traditional cell sorters which have one channel detector that measure the intensity of a signal, the classification workflow utilizes a whole image (e.g., 50 pixels×50 pixels) for processing including the intensity of the stain, the location of the stain and other aspects of the image. In some embodiments, fewer or additional steps are implemented. In some embodiments, the order of the steps is modified.

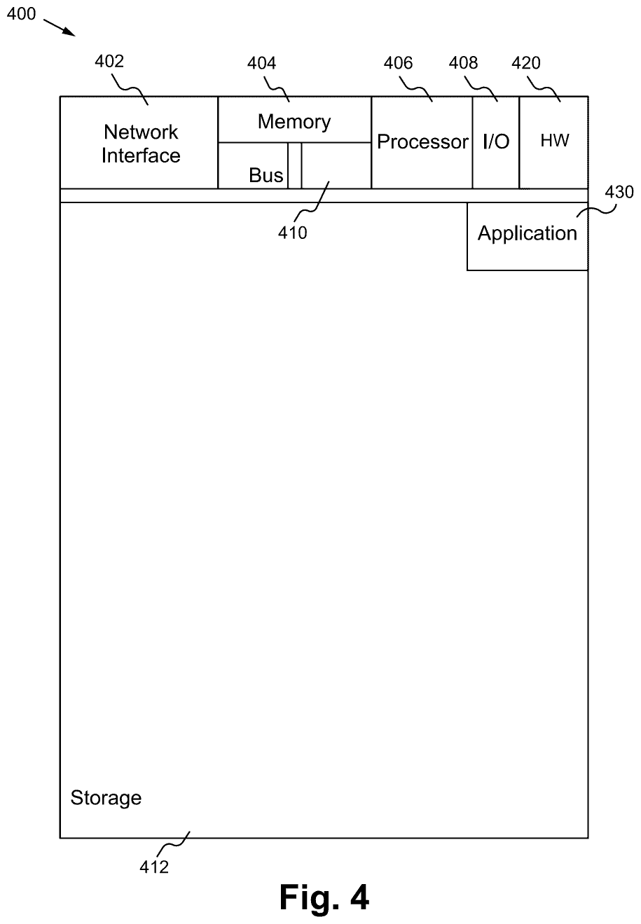

FIG. 4 shows a block diagram of an exemplary computing device configured to implement the IACS framework according to some embodiments. The computing device 400 is able to be used to acquire, store, compute, process, communicate and/or display information such as images and videos. The computing device 400 is able to implement any of the IACS framework aspects. In general, a hardware structure suitable for implementing the computing device 400 includes a network interface 402, a memory 404, a processor 406, I/O device(s) 408, a bus 410 and a storage device 412. The choice of processor is not critical as long as a suitable processor with sufficient speed is chosen. The memory 404 is able to be any conventional computer memory known in the art. The storage device 412 is able to include a hard drive, CDROM, CDRW, DVD, DVDRW, High Definition disc/drive, ultra-HD drive, flash memory card or any other storage device. The computing device 400 is able to include one or more network interfaces 402. An example of a network interface includes a network card connected to an Ethernet or other type of LAN. The I/O device(s) 408 are able to include one or more of the following: keyboard, mouse, monitor, screen, printer, modem, touchscreen, button interface and other devices. IACS framework application(s) 430 used to implement the IACS framework are likely to be stored in the storage device 412 and memory 404 and processed as applications are typically processed. More or fewer components shown in FIG. 4 are able to be included in the computing device 400. In some embodiments, IACS framework hardware 420 is included. Although the computing device 400 in FIG. 4 includes applications 430 and hardware 420 for the IACS framework, the IACS framework is able to be implemented on a computing device in hardware, firmware, software or any combination thereof. For example, in some embodiments, the IACS framework applications 430 are programmed in a memory and executed using a processor. In another example, in some embodiments, the IACS framework hardware 420 is programmed hardware logic including gates specifically designed to implement the IACS framework.

In some embodiments, the IACS framework application(s) 430 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, an augmented reality device, a virtual reality device, smart jewelry (e.g., smart watch), a vehicle (e.g., a self-driving vehicle) or any other suitable computing device.

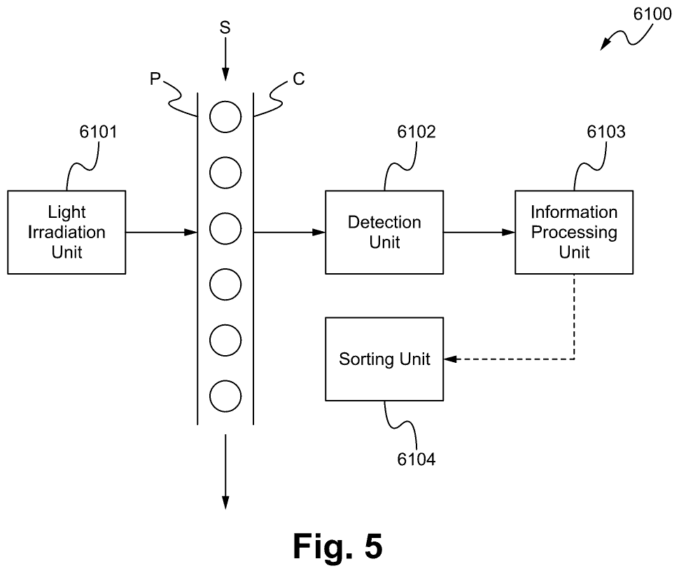

FIG. 5 illustrates a diagram schematically showing the overall configuration of a biological sample analyzer according to some embodiments.

FIG. 5 shows an example configuration of a biological sample analyzer of the present disclosure. A biological sample analyzer 6100 shown in FIG. 5 includes: a light irradiation unit 6101 that irradiates a biological sample S flowing in a flow channel C with light; a detection unit 6102 that detects light generated by irradiating the biological sample S; and an information processing unit 6103 that processes information about the light detected by the detection unit. The biological sample analyzer 6100 is a flow cytometer or an imaging cytometer, for example. The biological sample analyzer 6100 may include a sorting unit 6104 that sorts out specific biological particles P in a biological sample. The biological sample analyzer 6100 including the sorting unit is a cell sorter, for example.

### Biological Sample

The biological sample S may be a liquid sample containing biological particles. The biological particles are cells or non-cellular biological particles, for example. The cells may be living cells, and more specific examples thereof include blood cells such as erythrocytes and leukocytes, and germ cells such as sperms and fertilized eggs. Also, the cells may be those directly collected from a sample such as whole blood, or may be cultured cells obtained after culturing. The non-cellular biological particles are extracellular vesicles, or particularly, exosomes and microvesicles, for example. The biological particles may be labeled with one or more labeling substances (such as a dye (particularly, a fluorescent dye) and a fluorochrome-labeled antibody). Note that particles other than biological particles may be analyzed by the biological sample analyzer of the present disclosure, and beads or the like may be analyzed for calibration or the like.

### Flow Channel

The flow channel C is designed so that a flow of the biological sample S is formed. In particular, the flow channel C may be designed so that a flow in which the biological particles contained in the biological sample are aligned substantially in one row is formed. The flow channel structure including the flow channel C may be designed so that a laminar flow is formed. In particular, the flow channel structure is designed so that a laminar flow in which the flow of the biological sample (a sample flow) is surrounded by the flow of a sheath liquid is formed. The design of the flow channel structure may be appropriately selected by a person skilled in the art, or a known one may be adopted. The flow channel C may be formed in a flow channel structure such as a microchip (a chip having a flow channel on the order of micrometers) or a flow cell. The width of the flow channel C is 1 mm or smaller, or particularly, may be not smaller than 10 μm and not greater than 1 mm. The flow channel C and the flow channel structure including the flow channel C may be made of a material such as plastic or glass.

The biological sample analyzer of the present disclosure is designed so that the biological sample flowing in the flow channel C, or particularly, the biological particles in the biological sample are irradiated with light from the light irradiation unit 6101. The biological sample analyzer of the present disclosure may be designed so that the irradiation point of light on the biological sample is located in the flow channel structure in which the flow channel C is formed, or may be designed so that the irradiation point is located outside the flow channel structure. An example of the former case may be a configuration in which the light is emitted onto the flow channel C in a microchip or a flow cell. In the latter case, the biological particles after exiting the flow channel structure (particularly, the nozzle portion thereof) may be irradiated with the light, and a flow cytometer of a jet-in-air type can be adopted, for example.

### Light Irradiation Unit

The light irradiation unit 6101 includes a light source unit that emits light, and a light guide optical system that guides the light to the irradiation point. The light source unit includes one or more light sources. The type of the light source(s) is a laser light source or an LED, for example. The wavelength of light to be emitted from each light source may be any wavelength of ultraviolet light, visible light, and infrared light. The light guide optical system includes optical components such as beam splitters, mirrors, or optical fibers, for example. The light guide optical system may also include a lens group for condensing light, and includes an objective lens, for example. There may be one or more irradiation points at which the biological sample and light intersect. The light irradiation unit 6101 may be designed to collect light emitted onto one irradiation point from one light source or different light sources.

### Detection Unit

The detection unit 6102 includes at least one photodetector that detects light generated by emitting light onto biological particles. The light to be detected may be fluorescence or scattered light (such as one or more of the following: forward scattered light, backscattered light, and side scattered light), for example. Each photodetector includes one or more light receiving elements, and has a light receiving element array, for example. Each photodetector may include one or more photomultiplier tubes (PMTs) and/or photodiodes such as APDs and MPPCs, as the light receiving elements. The photodetector includes a PMT array in which a plurality of PMTs is arranged in a one-dimensional direction, for example. The detection unit 6102 may also include an image sensor such as a CCD or a CMOS. With the image sensor, the detection unit 6102 can acquire an image (such as a bright-field image, a dark-field image, or a fluorescent image, for example) of biological particles.

The detection unit 6102 includes a detection optical system that causes light of a predetermined detection wavelength to reach the corresponding photodetector. The detection optical system includes a spectroscopic unit such as a prism or a diffraction grating, or a wavelength separation unit such as a dichroic mirror or an optical filter. The detection optical system is designed to disperse the light generated by light irradiation to biological particles, for example, and detect the dispersed light with a larger number of photodetectors than the number of fluorescent dyes with which the biological particles are labeled. A flow cytometer including such a detection optical system is called a spectral flow cytometer. Further, the detection optical system is designed to separate the light corresponding to the fluorescence wavelength band of a specific fluorescent dye from the light generated by the light irradiation to the biological particles, for example, and cause the corresponding photodetector to detect the separated light.

The detection unit 6102 may also include a signal processing unit that converts an electrical signal obtained by a photodetector into a digital signal. The signal processing unit may include an A/D converter as a device that performs the conversion. The digital signal obtained by the conversion performed by the signal processing unit can be transmitted to the information processing unit 6103. The digital signal can be handled as data related to light (hereinafter, also referred to as “light data”) by the information processing unit 6103. The light data may be light data including fluorescence data, for example. More specifically, the light data may be data of light intensity, and the light intensity may be light intensity data of light including fluorescence (the light intensity data may include feature quantities such as area, height, and width).

### Information Processing Unit

The information processing unit 6103 includes a processing unit that performs processing of various kinds of data (light data, for example), and a storage unit that stores various kinds of data, for example. In a case where the processing unit acquires the light data corresponding to a fluorescent dye from the detection unit 6102, the processing unit can perform fluorescence leakage correction (a compensation process) on the light intensity data. In the case of a spectral flow cytometer, the processing unit also performs a fluorescence separation process on the light data, and acquires the light intensity data corresponding to the fluorescent dye. The fluorescence separation process may be performed by an unmixing method disclosed in JP 2011-232259 A, for example. In a case where the detection unit 6102 includes an image sensor, the processing unit may acquire morphological information about the biological particles, on the basis of an image acquired by the image sensor. The storage unit may be designed to be capable of storing the acquired light data. The storage unit may be designed to be capable of further storing spectral reference data to be used in the unmixing process.

In a case where the biological sample analyzer 6100 includes the sorting unit 6104 described later, the information processing unit 6103 can determine whether to sort the biological particles, on the basis of the light data and/or the morphological information. The information processing unit 6103 then controls the sorting unit 6104 on the basis of the result of the determination, and the biological particles can be sorted by the sorting unit 6104.

The information processing unit 6103 may be designed to be capable of outputting various kinds of data (such as light data and images, for example). For example, the information processing unit 6103 can output various kinds of data (such as a two-dimensional plot or a spectrum plot, for example) generated on the basis of the light data. The information processing unit 6103 may also be designed to be capable of accepting inputs of various kinds of data, and accepts a gating process on a plot by a user, for example. The information processing unit 6103 may include an output unit (such as a display, for example) or an input unit (such as a keyboard, for example) for performing the output or the input.

The information processing unit 6103 may be designed as a general-purpose computer, and may be designed as an information processing device that includes a CPU, a RAM, and a ROM, for example. The information processing unit 6103 may be included in the housing in which the light irradiation unit 6101 and the detection unit 6102 are included, or may be located outside the housing. Further, the various processes or functions to be executed by the information processing unit 6103 may be realized by a server computer or a cloud connected via a network.

### Sorting Unit

The sorting unit 6104 performs sorting of biological particles, in accordance with the result of determination performed by the information processing unit 6103. The sorting method may be a method by which droplets containing biological particles are generated by vibration, electric charges are applied to the droplets to be sorted, and the traveling direction of the droplets is controlled by an electrode. The sorting method may be a method for sorting by controlling the traveling direction of biological particles in the flow channel structure. The flow channel structure has a control mechanism based on pressure (injection or suction) or electric charge, for example. An example of the flow channel structure may be a chip (the chip disclosed in JP 2020-76736 A, for example) that has a flow channel structure in which the flow channel C branches into a recovery flow channel and a waste liquid flow channel on the downstream side, and specific biological particles are collected in the recovery flow channel.

To utilize the IACS framework described herein, devices such as a microscope with a camera are used to acquire content, and a device is able to process the acquired content. The IACS framework is able to be implemented with user assistance or automatically without user involvement.

In operation, the IACS framework is able to be used to sort cells in secretome applications. By using the IACS framework that identifies the event types present in a sample of carriers allows the user to select which event types they would like to purify, and then train a supervised classification system that will be used to make real time sort decisions to purify the carriers which contain cells that secrete the desired product. A flow cytometer is then able to be used to screen the individual carriers to see if each one has the desired secreted product. Millions of carriers are able to be placed in a tube (or other container) to do a large amount of sample preparation at once, instead of doing a plate-based approach which is much more complicated and a much slower process. Additionally, using a flow cytometer, screening is much faster. For example, roughly 1,000 cells are able to be screened in 20-30 minutes using the plate-based approach, whereas 3,000 cells per second are able to be screened using a flow cytometer.

### SOME EMBODIMENTS OF EXTENSION OF IACS FRAMEWORK TO SECRETOME APPLICATIONS

1. A method comprising:
   pre-training a feature encoder using cell images;
   performing unsupervised clustering on the cell images to generate a plurality of clusters, wherein each cluster of the plurality of clusters is based on a number of cells in a carrier;
   implementing a classifier to fine-tune supervised classification; and
   performing real-time classification of cells during active sorting using the classifier.
2. The method of clause 1 further comprising populating a plurality of carriers with a plurality of cells.
3. The method of clause 2 further comprising acquiring images of the carriers to generate the cell images.
4. The method of clause 1 wherein the feature encoder detects a target cell, a secretor cell or a secretion.
5. The method of clause 1 wherein a cluster of the plurality of clusters includes a single cell in each carrier.
6. The method of clause 1 wherein the carrier comprises a double emulsion.
7. The method of clause 1 wherein each cluster of the plurality of clusters is based on intensity and/or location of a fluorescence secretion signal.
8. An apparatus comprising:
   a non-transitory memory for storing an application, the application for:
      pre-training a feature encoder using cell images;
      performing unsupervised clustering on the cell images to generate a plurality of clusters, wherein each cluster of the plurality of clusters is based on a number of cells in a carrier;
      implementing a classifier to fine-tune supervised classification; and
      performing real-time classification of cells during active sorting using the classifier; and
   a processor coupled to the memory, the processor configured for processing the application.
9. The apparatus of clause 8 wherein the plurality of carriers are populated with a plurality of cells.
10. The apparatus of clause 9 wherein the application is further for acquiring images of the carriers to generate the cell images.
11. The apparatus of clause 8 wherein the feature encoder detects a target cell, a secretor cell or a secretion.
12. The apparatus of clause 8 wherein a cluster of the plurality of clusters includes a single cell in each carrier.
13. The apparatus of clause 8 wherein the carrier comprises a double emulsion.
14. The apparatus of clause 8 wherein each cluster of the plurality of clusters is based on intensity and/or location of a fluorescence secretion signal.
15. A system comprising:
   a first device configured for acquiring images of carriers; and
   a second device configured for:
      pre-training a feature encoder using cell images;
      performing unsupervised clustering on the cell images to generate a plurality of clusters, wherein each cluster of the plurality of clusters is based on a number of cells in a carrier;
      implementing a classifier to fine-tune supervised classification; and
      performing real-time classification of cells during active sorting using the classifier.
16. The system of clause 15 wherein the plurality of carriers are populated with a plurality of cells.
17. The system of clause 16 wherein the second device is further configured for generating the cell images from the carriers.
18. The system of clause 15 wherein the feature encoder detects a target cell, a secretor cell or a secretion.
19. The system of clause 15 wherein a cluster of the plurality of clusters includes a single cell in each carrier.
20. The system of clause 15 wherein the carrier comprises a double emulsion.
21. The system of clause 15 wherein each cluster of the plurality of clusters is based on intensity and/or location of a fluorescence secretion signal.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method comprising:
pre-training a feature encoder using cell images;
performing unsupervised clustering on the cell images to generate a plurality of clusters, wherein each cluster of the plurality of clusters is based on a number of cells in a carrier;
implementing a classifier to fine-tune supervised classification; and
performing real-time classification of cells during active sorting using the classifier.

2. The method of claim 1 further comprising populating a plurality of carriers with a plurality of cells.

3. The method of claim 2 further comprising acquiring images of the carriers to generate the cell images.

4. The method of claim 1 wherein the feature encoder detects a target cell, a secretor cell or a secretion.

5. The method of claim 1 wherein a cluster of the plurality of clusters includes a single cell in each carrier.

6. The method of claim 1 wherein the carrier comprises a double emulsion.

7. The method of claim 1 wherein each cluster of the plurality of clusters is based on intensity and/or location of a fluorescence secretion signal.

8. An apparatus comprising:
a non-transitory memory for storing an application, the application for:
pre-training a feature encoder using cell images;
performing unsupervised clustering on the cell images to generate a plurality of clusters, wherein each cluster of the plurality of clusters is based on a number of cells in a carrier;
implementing a classifier to fine-tune supervised classification; and
performing real-time classification of cells during active sorting using the classifier; and
a processor coupled to the memory, the processor configured for processing the application.

9. The apparatus of claim 8 wherein the plurality of carriers are populated with a plurality of cells.

10. The apparatus of claim 9 wherein the application is further for acquiring images of the carriers to generate the cell images.

11. The apparatus of claim 8 wherein the feature encoder detects a target cell, a secretor cell or a secretion.

12. The apparatus of claim 8 wherein a cluster of the plurality of clusters includes a single cell in each carrier.

13. The apparatus of claim 8 wherein the carrier comprises a double emulsion.

14. The apparatus of claim 8 wherein each cluster of the plurality of clusters is based on intensity and/or location of a fluorescence secretion signal.

15. A system comprising:
a first device configured for acquiring images of carriers; and
a second device configured for:
pre-training a feature encoder using cell images;
performing unsupervised clustering on the cell images to generate a plurality of clusters, wherein each cluster of the plurality of clusters is based on a number of cells in a carrier;
implementing a classifier to fine-tune supervised classification; and
performing real-time classification of cells during active sorting using the classifier.

16. The system of claim 15 wherein the plurality of carriers are populated with a plurality of cells.

17. The system of claim 16 wherein the second device is further configured for generating the cell images from the carriers.

18. The system of claim 15 wherein the feature encoder detects a target cell, a secretor cell or a secretion.

19. The system of claim 15 wherein a cluster of the plurality of clusters includes a single cell in each carrier.

20. The system of claim 15 wherein the carrier comprises a double emulsion.

21. The system of claim 15 wherein each cluster of the plurality of clusters is based on intensity and/or location of a fluorescence secretion signal.
